(19) United States
(12) Patent Application Publication
(10) Pub. No.: US 2010/0059638 A1
(43) Pub. Date: Mar. 11, 2010

(54) Accessory connection device for bicycles

(76) Inventor: Keiji Taiga, Tokyo (JP)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,115

(22) Filed: Sep. 11, 2008

(51) Int. Cl. F16M 13/00

(52) U.S. Cl. 248/124.1

(57) ABSTRACT

A connection device for connecting accessories to bicycle frame includes first fasteners having a first end threadedly connected to a bicycle part such as a handlebar and second fasteners are threadedly connected to second ends of the first fasteners. A connection unit is connected between the first and second fasteners. The connection unit can be different shapes and function so as to be connected with different accessories such as light bulb, water bottle or storage bag.

### FIELD OF THE INVENTION

The present invention relates to a connection device and more particularly, to an accessory connection device for conveniently connecting accessories to bicycles.

### BACKGROUND OF THE INVENTION

There are lots of accessories to be connected to a bicycle such as light set and water bottle, and these accessories are optional parts for the riders and can be connected to the bicycle frame by individual connection devices. The light set is cooperated with an unique connection device and the water bottle is cooperated with another connection device. Therefore, the rider has to purchase several different shapes of connection devices for different accessories.

A conventional connection device for a light set generally includes a light frame which has two arms so as to position a light unit between the two arms. The light frame is secured to the bicycle handlebar and each arm includes a through hole and a notch which is communicates with the through hole. A flexible ring is mounted to the two arms and in contact with light unit. The flexible ring is engaged with the through holes so that the flexible ring does not shift.

A conventional connection device for a water bottle generally includes a base and a frame so that the water bottle can be positioned between the base and the frame. A connection unit includes a first connection member and a second connection member, wherein the first connection member is connected to the base and the second connection member is connected to the frame and adjustable relative to the first connection member. By adjusting the second connection member, the water bottle can be positioned at desired angle.

Both of the two conventional connection devices include too many parts and have only one function for specific accessory. In other words, the parts of the two connection devices are completely different, once one of the parts is missing, the whole connection device cannot be functioned.

The present invention intends to provide a connection device for connection different accessories to bicycle frame by common parts.

### SUMMARY OF THE INVENTION

The present invention relates to a connection device which comprises at least one first fastener having a first end threadedly connected to a bicycle part, at least one second fastener threadedly connected to a second end of the at least one first fastener, and a connection unit which is connected between the at least one first fastener and the at least one second fastener. The connection unit is designed for different accessories such as light bulb, water bottle or storage bag.

The primary object of the present invention is to provide a connection device for connecting accessories to bicycle frame and the connection device includes less number of parts which can be cooperated with different connection units for different accessories.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the connection device of the present invention cooperated with a light frame on the handlebar stem;

FIG. 2 is an exploded view to show the connection device of the present invention and the light frame on the handlebar stem;

FIG. 3 is a cross sectional view to show the connection device of the present invention and the light frame on the handlebar stem;

FIG. 4 is a perspective view to show the connection device of the present invention cooperated with a water bottle frame on the handlebar stem;

FIG. 5 is an exploded view to show the connection device of the present invention and the water bottle frame on the handlebar stem;

FIG. 6 is a perspective view to show the connection device of the present invention cooperated with a bag frame on the seat post;

FIG. 7 is an exploded view to show the connection device of the present invention and the bag frame on the seat post;

FIG. 8 is a perspective view to show the connection device of the present invention cooperated with a front brake mechanism on the front fork;

FIG. 9 is an exploded view to show the connection device of the present invention and the front brake mechanism on the front fork, and

FIG. 10 is a cross sectional view to show the connection device of the present invention and the front brake mechanism on the front fork.

### DETAILED DESCRIPTION OF THE PREFERRED EMBODIMENT

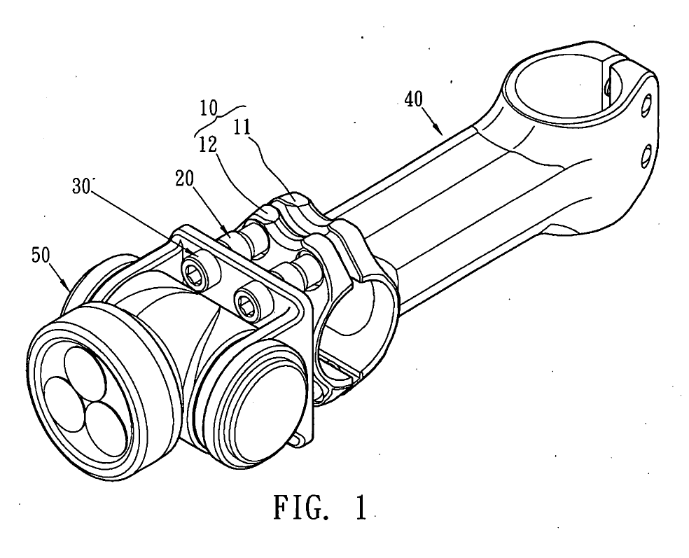

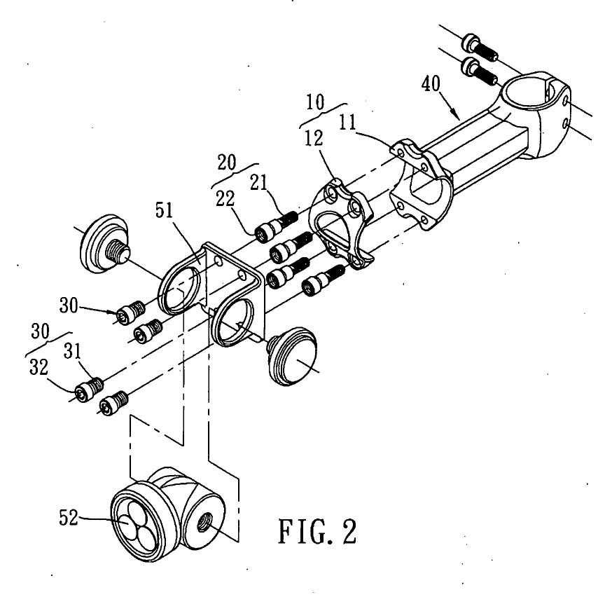

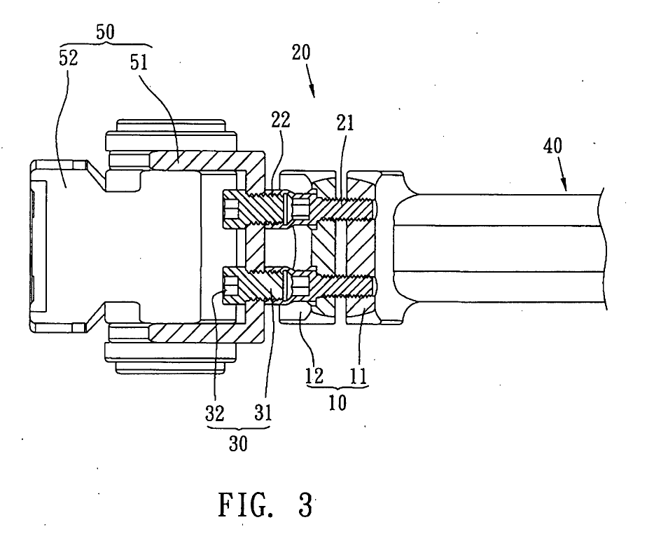

Referring to FIGS. 1 to 3, the connection device of the present invention is designed to connecting accessories to bicycle frame, and in this embodiment, the connection device is designed to connect a front light set to the handlebar stem 40, and comprises a clamping unit 10, four first fasteners 20, four second fasteners 30, the handlebar stem 40 and a connection unit 50 which includes the front light set. The four first fasteners 20 each have a threaded section 21 at a first end thereof and a threaded hole 22 defined in a second end thereof. Four second fasteners 30 each have a second threaded section 31 at a first end thereof and a driving head 32 at a second end thereof. The second threaded sections 31 of the second fasteners 30 are to be threadedly connected to the threaded holes 22 of the first fasteners 20 respectively. The driving head 32 has an engaging recess defined therein and a tool such as a screw driver can be engaged with the engaging recess to rotate the second fasteners 20.

The clamping unit 10 includes a first clamp member 11 and a second clamp member 12, wherein the first clamp member 11 is integrally formed with the handlebar stem 40. A clamp space is defined between the first and second clamp members 11, 12 such that the handlebar is secured between the first and second clamp members 11, 12. The first fasteners 20 are threadedly connected to the clamping unit 10 so as to move the first and second clamp members 11, 12 toward each other.

The connection unit 50 is connected between the first fasteners 20 and the second fasteners 30, and includes a light frame 51 which is a U-shaped frame and a light bulb 52 is pivotably connected between two arm plates of the light frame 51. The four second fasteners 30 extend through the light frame 51 and are connected to the first fasteners 20 to fix the light frame 51 to the second clamping member 12 of the clamping unit 10.

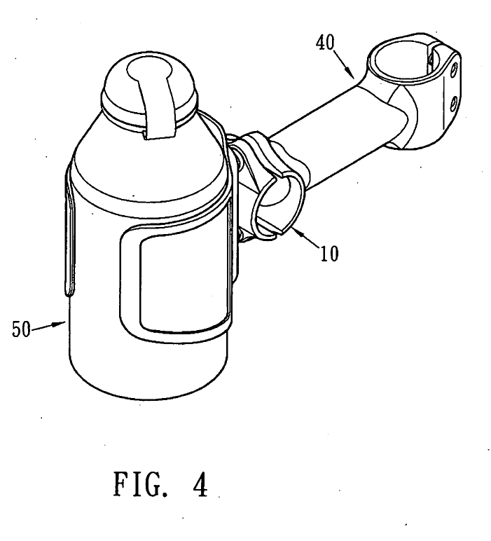

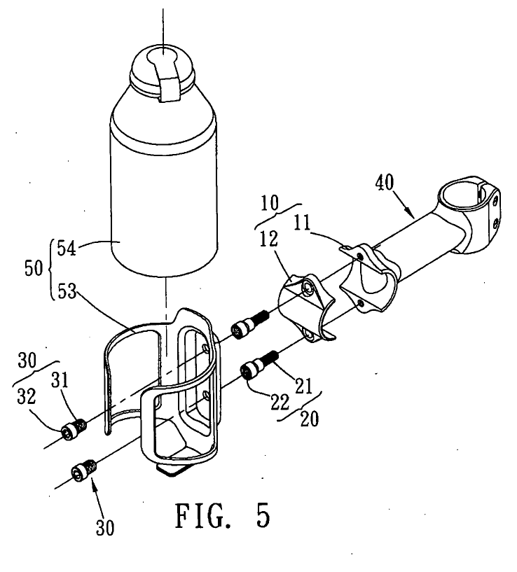

FIGS. 4 and 5 show that the connection unit 50 is a water bottle frame 53 which includes two curved arm plates and a bottom support plate so as to hold a water bottle 54 in the water bottle frame 53. There only need two first fasteners 20 and two second fasteners 30.

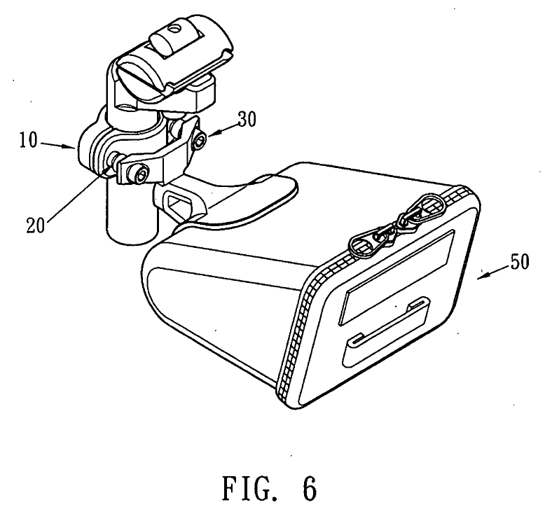

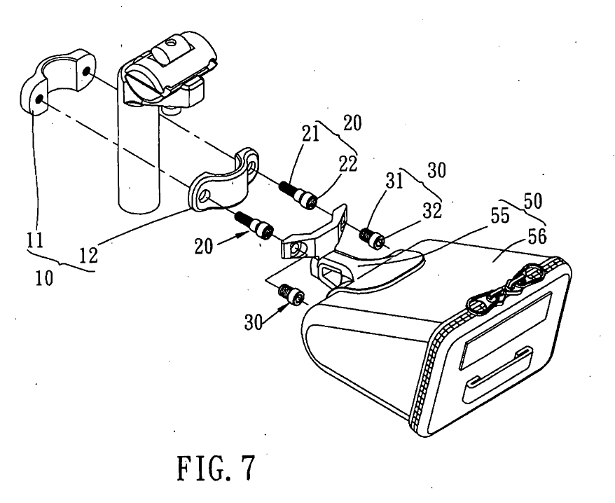

FIGS. 6 and 7 show that the connection unit 50 is a bag frame 55 which is fixed to the seat post. The first and second clamp members 11, 12 clamp the seat post by two first fasteners 20 and the bag frame 55 includes an elongate connection plate at one end and a bag 56 is fixed to the other end of the bag frame 55. The elongate connection plate is fixed to the second clamp member 12 by two second fasteners 30.

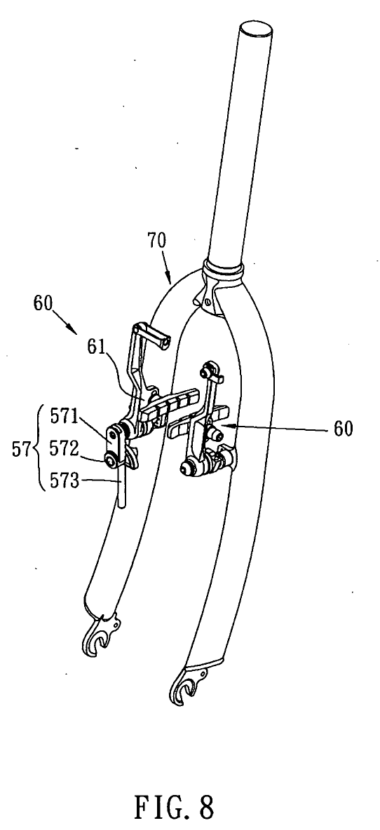

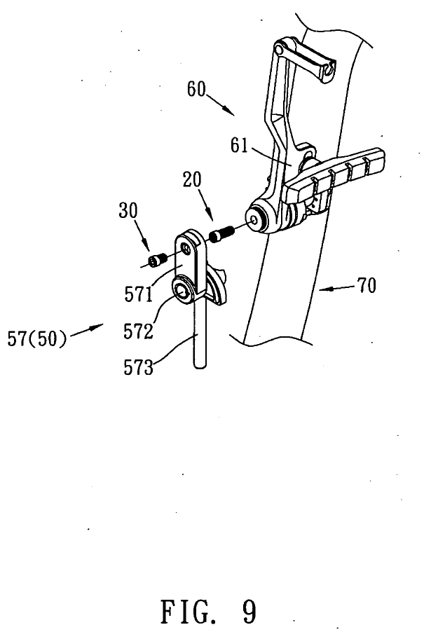

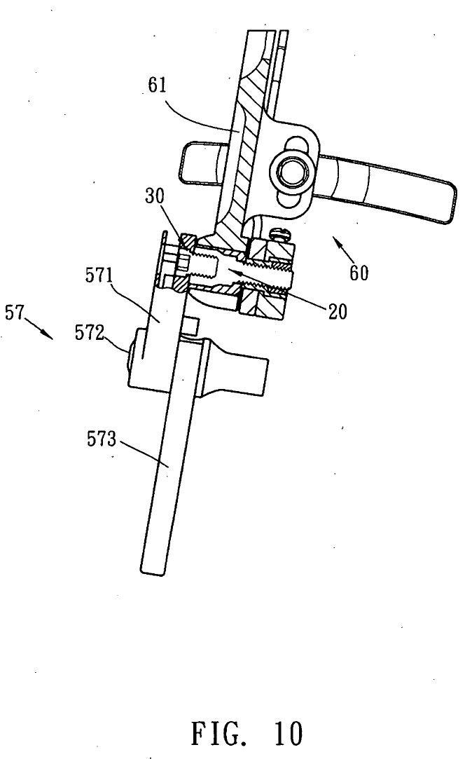

FIGS. 8 to 10 show that the connection device 50 of the present invention is cooperated with a front brake mechanism on the front fork 70. The bicycle frame 60 is the front brake mechanism and includes a brake arm 61 connected to a front fork 70 and the first fastener 20 fixes the brake arm 61 to the front fork 70. The connection unit 50 is a locking unit 57 which includes a locking member 571 and the second fastener 30 extends through the locking member 571 and connected to the first fastener 20. The locking unit 57 includes a fastening member 572 which is connected to the locking member 571, and a rod 573 which is pivotably connected to the locking member 571. The fastening member 572 drives the rod 573 to rotate relative to the locking member 571.

By the connection of the first and second fasteners 20, 30, the connection unit 50 can be fixed to the bicycle frame and the connection unit 50 can be designed to have different shapes and functions so as to connect different accessories to the bicycle. It is noted that only the connection unit 50 needs to be changed when connecting different accessories to the bicycle.

While we have shown and described the embodiment in accordance with the present invention, it should be clear to those skilled in the art that further embodiments may be made without departing from the scope of the present invention.

What is claimed is:

1. A connection device comprising:
at least one first fastener having a first end threadedly connected to a bicycle part;
at least one second fastener threadedly connected to a second end of the at least one first fastener, and
a connection unit being connected between the at least one first fastener and the at least one second fastener.

2. The device as claimed in claim 1, wherein a clamping unit including a first clamp member and a second clamp member, the bicycle part is clamped between the first and second clamp members, the at least one first fastener is threadedly connected to the clamping unit so as to move the first and second clamp members toward each other, the connection unit is fixed to the clamping unit by the at least one second fastener.

3. The device as claimed in claim 2, wherein the clamping unit is located at an end of a handlebar stem and the first clamp member is integrally formed with the handlebar stem.

4. The device as claimed in claim i, wherein the at least one first fastener includes a threaded section at the first end thereof and a threaded hole defined in the second end thereof, the threaded section extends through the first and second clamp members, the at least one second fastener is threadedly connected to the threaded hole in the at least one first fastener.

5. The device as claimed in claim 4, wherein the at least one second fastener has a second threaded section at a first end thereof and a driving head at a second end thereof, the second threaded section of the at least one second fastener is threadedly connected to the threaded hole of the at least one first fastener, the driving head is adapted to be engaged with tools.

6. The device as claimed in claim 5, wherein the driving head has an engaging recess defined therein.

7. The device as claimed in claim 6, wherein the engaging recess in the driving head is a polygonal recess.

8. The device as claimed in claim 1, wherein the connection unit includes a light frame and the at least one second fastener extends through the light frame and are connected to the at least one first fastener.

9. The device as claimed in claim 8, wherein a light bulb is pivotably connected to the light frame.

10. The device as claimed in claim 1, wherein the connection unit includes a water bottle frame the at least one second fastener extends through the water bottle frame and is connected to the at least one first fastener.

11. The device as claimed in claim 1, wherein the connection unit includes a bag frame and the at least one second fastener extends through the bag frame and is connected to the at least one first fastener.

12. The device as claimed in claim 1, wherein the bicycle frame is the front brake mechanism and includes a brake arm connected to a front fork and the at least one first fastener fixes the brake arm to the front fork, the connection unit is a locking unit which includes a locking member and the at least one second fastener extends through the locking member and connected to the at least one first fastener.

13. The device as claimed in claim 12, wherein the locking unit includes a fastening member which is connected to the locking member, and a rod which is pivotably connected to the locking member, the fastening member drives the rod to rotate relative to the locking member.
